(19) United States
(12) Patent Application Publication
(10) Pub. No.: US 2020/0406183 A1
(43) Pub. Date: Dec. 31, 2020

(54) SYSTEMS, APPARATUS AND METHODS FOR SEPARATING OXYGEN FROM AIR

(71) Applicant: O2 Industries Inc., Kitchener (CA)

(72) Inventors: John Grousopoulos, Kitchener (CA); Christopher Hajduk, Puslinch (CA)

(21) Appl. No.: 16/979,003

(22) PCT Filed: Mar. 8, 2019
(86) PCT No.: PCT/CA2019/050288

§ 371 Date: Sep. 8, 2020

Related U.S. Application Data
(60) Provisional application No. 62/640,997, filed on Mar. 9, 2018.

(51) Int. Cl. B01D 53/04; B01J 20/22; B01J 20/28

(52) U.S. Cl. CPC B01D 53/0462; B01J 20/223; B01J 20/28007; B01D 2259/4541; B01D 2253/20; B01D 2257/104; B01D 2259/40009; B01J 20/28052

(57) ABSTRACT

Examples of systems, apparatus and methods for separating oxygen from air are provided herein. The system comprises a separating column that includes an oxygen separating compound packed in the column for selectively and reversibly binding oxygen from the air and for releasing the selectively bound oxygen upon being heated, a heater thermally coupled to the separating column, a heat removal apparatus and an air flow controller.

### TECHNICAL FIELD

The embodiments disclosed herein relate to the separation of oxygen from air, and, in particular to the separation of oxygen from air by rapid cycle temperature swing absorption.

### INTRODUCTION

Portable oxygen generators are portable, primarily electric, devices designed to concentrate oxygen from ambient air and deliver the concentrated oxygen, to a patient requiring oxygen therapy, typically through an attached nasal cannula. Ambient air is generally processed by portable oxygen generators using an internal filtration system that separates oxygen from the ambient air.

Current oxygen generators typically rely on a change in pressure to separate oxygen from the air and are therefore known as pressure-swing absorption systems. Pressure swing adsorption systems have been the primary devices for separating oxygen from air for use in low volume applications such as portable oxygen concentrators since the beginning of the 21st century.

Pressure-swing absorption systems require heavy and power intensive compressors and therefore are generally difficult to transport.

### SUMMARY

According to one aspect, a system for separating oxygen from air is described. The system includes a separating column comprising: an inlet; an outlet downstream from the inlet; a body connected to the inlet and the outlet; and an oxygen separating compound packed inside the body, the oxygen separating compound configured to selectively and reversibly bind oxygen from air received through the inlet upon contact with the air and to release the selectively bound oxygen upon being heated; a heater thermally coupled to the separating column to provide the heat to the separating column for releasing the selectively bound oxygen from the oxygen separating compound; a heat removal apparatus to remove heat from the oxygen separating compound; and an air flow controller for controlling entry of the air into the separating column and release of the bound oxygen from the separating column.

According to one aspect, the oxygen separating compound is a chelating compound.

According to one aspect, the oxygen separating compound is fluomine or a derivative of fluomine.

According to one aspect, the system has a first state where oxygen is being selectively bound to the oxygen separating compound and a second state where the selectively bound oxygen is released from the oxygen separating compound.

According to one aspect, the temperature of the oxygen separating compound when the system is in the second state is in a range of from about 40° C. to 120° C.

According to one aspect, the temperature of the oxygen separating compound when the system is in the second state is in a range of from 60° C. to 100° C.

According to one aspect, the temperature of the oxygen separating compound when the system is in the second state is in a range of from about 80° C. to 90° C.

According to one aspect, the heat removal apparatus is a cooling block positioned adjacent to the separating column to remove heat from the separating column.

According to one aspect, the cooling block comprises a liquid for removing heat from the oxygen separating compound.

According to one aspect, the liquid is water, ethylene glycol, diethylene glycol, propylene glycol or a mixture thereof.

According to one aspect, the separating column further comprises a high surface area structure disposed in the body to transfer heat from the heater to the oxygen separating compound.

According to one aspect, the high surface area structure comprises compartments for retaining the oxygen generating compound.

According to one aspect, the system further includes a vacuum pump for removing the selectively bound oxygen from the separation column once the selectively bound oxygen has been released from the oxygen separating compound.

According to one aspect, the inlet of the separation column is an outlet for the selectively bound oxygen.

According to one aspect, the system further includes more than one separation column operating in series.

According to one aspect, the system further includes three separation columns configured to provide a continuous supply of oxygen.

According to one aspect, the oxygen separating compound has a particle size in a range of about 50 μm to 50 nm.

According to one aspect, the separation column is removable from the system.

According to one aspect, the system further comprises at least one sensor for monitoring system conditions.

According to one aspect, the at least one sensor is one of a heat sensor, a color sensor, an energy sensor, a pressure sensor, an oxygen flow rate sensor and an oxygen concentration sensor.

According to one aspect, the system further includes a controller configured to receive information from the one or more sensors and control.

According to one aspect, in response to the received information, the controller controls system parameters to minimize oxygen degradation over time.

According to one aspect, in response to the received information, the controller controls a cycle time of the system to produce more oxygen per second.

According to one aspect, in response to the received information, the controller controls a degradation of the oxygen separating compound by minimizing a time that the system spends operating in the second state.

According to one aspect, a device for separating oxygen from air is described. The device includes an inlet; an outlet downstream from the inlet; and a body connected to the inlet and the outlet, the body configured to house an oxygen separating compound inside the body, the oxygen separating compound configured to selectively and reversibly bind oxygen from air received through the inlet upon contact with the air and to release the selectively bound oxygen upon being heated, the body configured to receive heat from a heater to release the selectively bound oxygen from the oxygen separating compound; the body configured to provide heat to a heat removal apparatus to remove heat from the oxygen separating compound; the body coupled to an air flow controller for controlling entry of the air into the body and release of the bound oxygen from the body.

According to one aspect, the oxygen separating compound is a chelating compound.

According to one aspect, the oxygen separating compound is fluomine or a derivative of fluomine.

According to one aspect, the device has a first state where oxygen is being selectively bound to the oxygen separating compound and a second state where the selectively bound oxygen is released from the oxygen separating compound.

According to one aspect, the temperature of the oxygen separating compound when the device is in the second state is in a range of from about 40° C. to 120° C.

According to one aspect, the temperature of the oxygen separating compound when the device is in the second state is in a range of from 60° C. to 100° C.

According to one aspect, the temperature of the oxygen separating compound when the device is in the second state is in a range of from about 80° C. to 90° C.

According to one aspect, the heat removal apparatus is a cooling block positioned adjacent to the body to remove heat from the body.

According to one aspect, the cooling block comprises a liquid for removing heat from the oxygen separating compound.

According to one aspect, the liquid is water, ethylene glycol, diethylene glycol, propylene glycol or a mixture thereof.

According to one aspect, the body further comprises a high surface area structure disposed in the body to transfer heat from the heater to the oxygen separating compound.

According to one aspect, the high surface area structure

According to one aspect, the body is coupled to a vacuum pump for removing the selectively bound oxygen from the body once the selectively bound oxygen has been released from the oxygen separating compound.

According to one aspect, the inlet of the body is an outlet for the selectively bound oxygen.

According to one aspect, the oxygen separating compound has a particle size in a range of about 50 μm to 50 nm.

According to one aspect, the body is removable from an oxygen separation system.

According to one aspect, the device further comprises at least one sensor for monitoring system conditions.

According to one aspect, the at least one sensor is one of a heat sensor, a color sensor, an energy sensor, a pressure sensor, an oxygen flow rate sensor and an oxygen concentration sensor.

According to one aspect, a method for separating oxygen from air is provided. The method includes receiving the air at a device for separating oxygen from the air, the device having a body configured to house an oxygen separating compound, the oxygen separating compound configured to selectively and reversibly bind oxygen from the air and to release the selectively bound oxygen upon being heated; applying heat to the oxygen separating compound to release the selectively bound oxygen; and extracting the selectively bound oxygen from the device.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a schematic airflow diagram of a temperature swing oxygen device, according to one embodiment;

FIG. 2 is a schematic airflow diagram of a temperature swing oxygen device, according to another embodiment;

FIG. 3 is a schematic airflow diagram of a temperature swing oxygen device, according to another embodiment;

FIG. 4 is a schematic airflow diagram of a portion of the airflow diagram of FIG. 1;

FIG. 5 is a is a schematic airflow diagram of a separation column of a temperature swing oxygen device, according to one embodiment;

FIG. 6 is a schematic airflow diagram of a temperature swing oxygen device, according to another embodiment;

FIG. 7 is a schematic airflow diagram of a temperature swing oxygen device, according to another embodiment;

FIG. 8 is a schematic airflow diagram of a temperature swing oxygen device, according to another embodiment;

FIG. 9 is a schematic airflow diagram of a temperature swing oxygen device, according to another embodiment;

FIG. 10 is a diagram showing the interior elements of the device of FIG. 9;

FIG. 11 is a graph showing fluomine capacity shown as a weight loss where each step is in 5° C. increments; and

FIG. 12 is a block diagram showing a software flow to continuously monitor and adjust oxygen separating compound performance.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

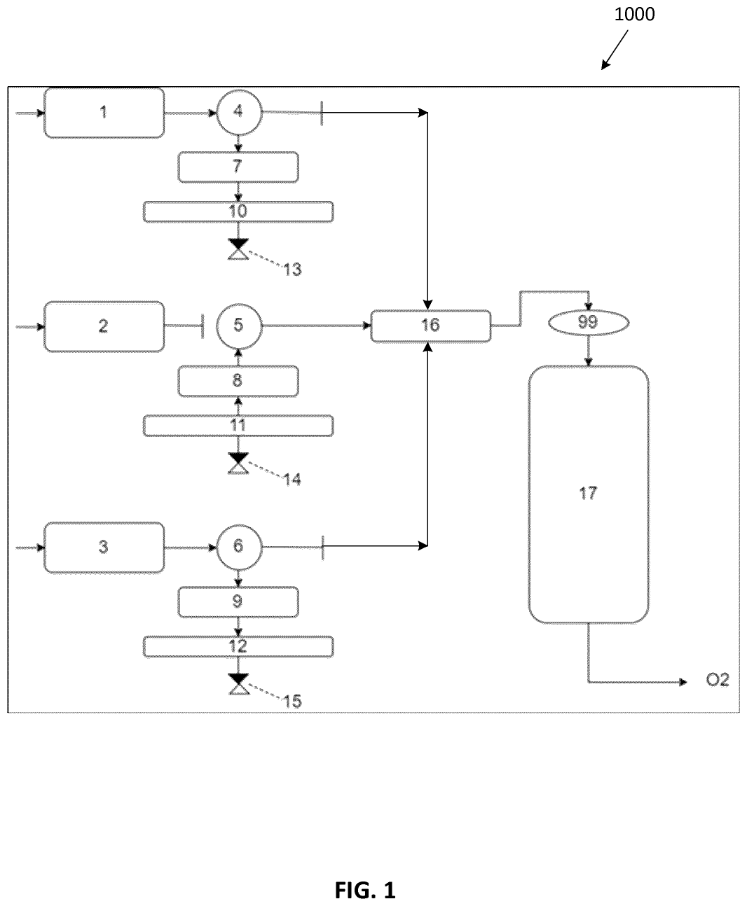

Referring to FIG. 1, illustrated therein is a system 1000 for separating oxygen from air and/or for producing a product gas stream that is rich in oxygen (e.g. primarily oxygen). The device 1000 includes a separation column for separating the oxygen from the air. In the embodiment shown in FIG. 1, three separation columns 10,11,12 are shown for device 1000. Separation columns 10,11,12 each have at least two states: a first state where the separation column is absorbing oxygen from air (e.g. state 1) and a second state where the separation column is releasing oxygen to a product stream (e.g. state 2). For device 1000 to continuously provide a product gas stream that is rich in oxygen, two separators are required so one separation column is always in the second state and releasing oxygen to the product stream. In the embodiment shown in FIG. 1, three separation columns are provided so that one separation column can be in the first state, one separation column can be in the second state and one separation column can be transitioning between the first and second states.

FIG. 1 shows air being pumped into each of the columns using three or more air pumps 1,2,3. If the separation column is in state 1 where it is absorbing oxygen, the air is directed through a three-way valve 4,5,6 and into a desiccation chamber 7,8,9. For example, in FIG. 1, the three-way valves 4 and 6 are shown as being in the first state where the separation columns 10 and 12, respectively, are absorbing oxygen from air and the three-way valve 5 is shown as being in the second state where the separation column 11 is releasing oxygen.

As the air passes through the three-way valves 4,5,6 to enter the separation columns 10,11,12, respectively, when the separation columns 10,11,12 are in the first state, the air is dried of any moisture by passing through a desiccation chamber 7,8,9, respectively, prior to entering the separation columns 10,11,12.

The dry air passing out of a desiccation chamber 7,8,9, continues into the separation column 10,11,12, respectively. Separation columns 10,11,12 are each packed full of an oxygen separating compound (not shown) for separating the oxygen from the air. In some embodiments, the oxygen separating compound is a chelating compound. In other embodiments, the oxygen separating compound is a metal organic complex. For instance, in some embodiments, the oxygen separating compound can be one of fluomine (i.e. cobalt bis(3-fluorosalicylaldehyde) ethylene diimine), a deriviative of fluomine, N,N′-Bis(salicylidene)ethylenediaminocobalt(II) (i.e. Cobalt Salen or Salcomine), N,N′-diethyleneamine bis(salicylideneimine), N′N′-imino-di-n-propylbis(salicylideneiminato)cobalt(II), Bis(acetylacetone)ethylenediimineocobalt(II) (i.e. cobalt acacen) and [(bpbp)Co2III(O₂)}2(bdc)](PF₆)₄; where bpbp-=2,6-bis(N,N-bis(2-pyridylmethyl)aminomethyl)-4-tert-butylphenolato, and bdc₂-=1,4-benzenedicarboxylato, (i.e. aquaman crystal).

The oxygen separating compound is configured to selectively absorb oxygen from the air while all other atmospheric gases present in the air are vented through one of the one way valves 13,14,15 that purge these gases back into the surroundings. Once the oxygen separating compound packed into the separation columns 10,11,12 is loaded with oxygen to a predetermined capacity, the column state switches from the first state to the second state whereby the oxygen can be released. To release the oxygen from the oxygen separating compound, the three-way valve 4,5,6 can be closed to inhibit additional air from entering the separation column 10,11,12, respectively, and heat can be applied to the column to separate the oxygen from the oxygen separating compound (as further described below).

In some embodiments, the oxygen separated from the air in separation columns 10,11,12 during the first state can be collected during the second state with a vacuum pump 16, as shown in FIG. 1, and either stored in an accumulation chamber 17 or delivered directly to an outlet of the device.

It should also be noted that when the separation columns 10,11,12 are in the second state (e.g. separation column 11 in FIG. 1), the oxygen produced in separation columns 10,11,12 may pass through the desiccation chambers 7,8,9, respectively, as it moves towards accumulation chamber 17 for storage or towards the outlet. In some embodiments, the oxygen produced in separation columns 10,11,12 may bypass the desiccation chambers 7,8,9 as it moves towards accumulation chamber 17 for storage or towards the outlet. Desiccation chambers 7,8,9 include a desiccant (not shown) for drying the air. The desiccant may be but is not limited to silica.

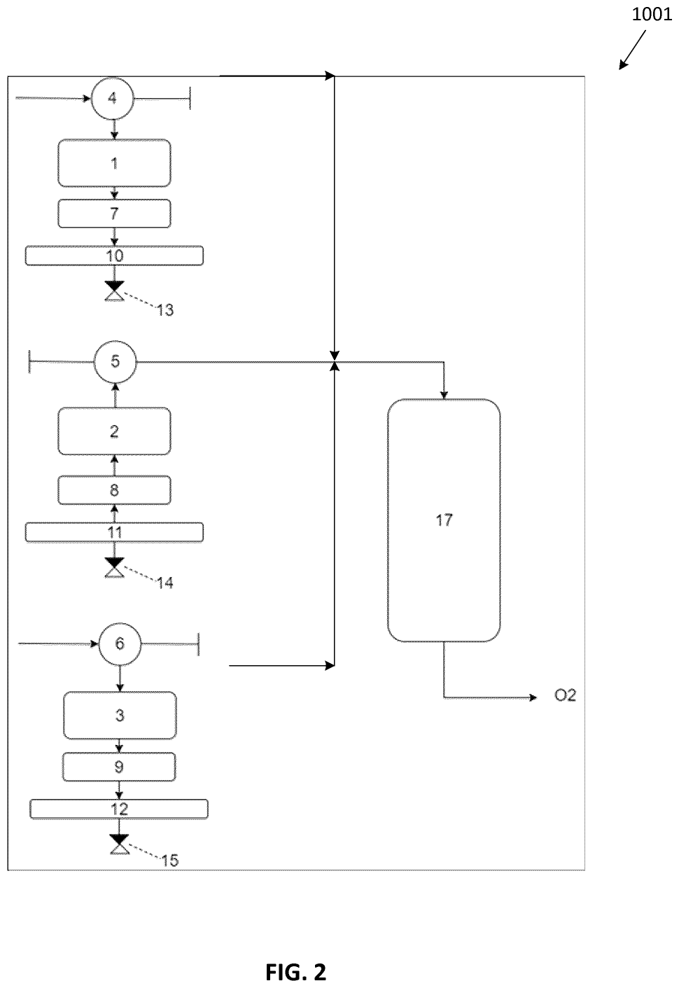

FIG. 2 shows a configuration of another device 1001 where the air pumps 1,2,3 have been shifted to be between the one way valves 13,14,15 and the desiccation chambers 7,8,9. In this embodiment, the pumps 1,2,3 can operate during both of the first state and second state to administer air or to remove oxygen from the oxygen separating compound, respectively. Further, it should be noted that in this embodiment, the vacuum pump 16 as shown in FIG. 1 is no longer needed.

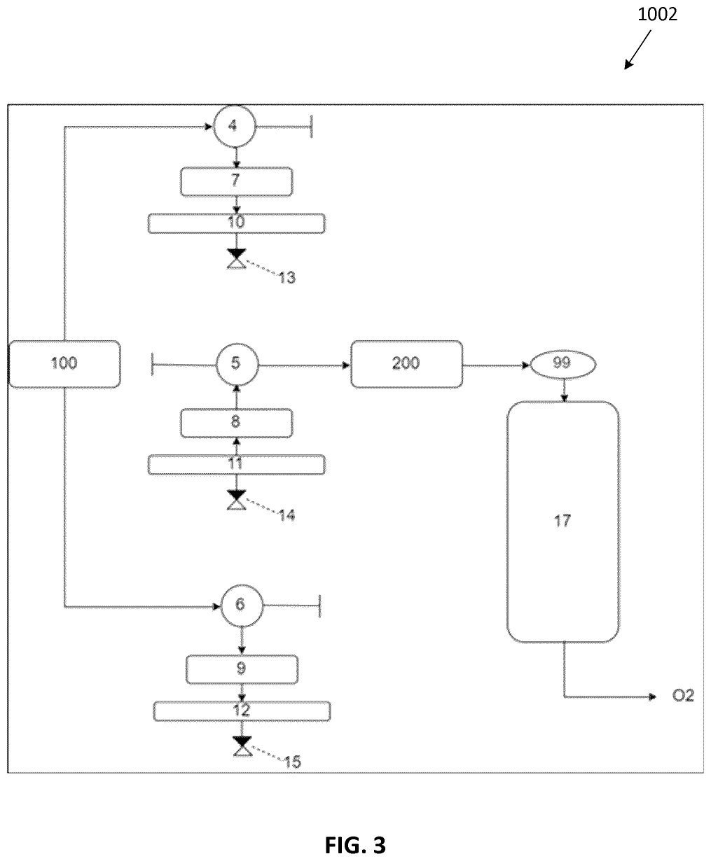

FIG. 3 shows another embodiment of a device 1002 where the air pumps 1,2,3 have been removed from the device and the air is supplied to each three-way valve 4,5,6 with a single supply pump 100. In this embodiment, oxygen can be separated from the air in the same manner as was previously described with reference to FIG. 1. Again, oxygen from the air can selectively bind to an oxygen separating compound in the separation columns 10,11,12 and can be controllably released from the separation columns 10,11,12 upon being heated (as described below). Oxygen that is released from the separation columns 10,11,12 can then be collected by an extraction pump 200 that directs the oxygen through an optional filtration means 99 towards accumulator 17 or, alternatively, directly to the user. In some embodiments, filtration means 99 may be added before the accumulator 17 to remove any volatilizable compounds which may off-gas from any of the separation columns 10,11,12.

The skilled person will understand that the oxygen separating compound packed into separation columns 10,11,12 has a limited useful lifetime wherein it can absorb and release oxygen from air. This limited useful lifetime is a function of how quickly the oxygen separating compound oxidizes irreversibly. For instance, how quickly the oxygen separating compound oxidizes irreversibly can change the electronic structure of the oxygen separating compound and render it incapable of separating oxygen from the air (i.e. incapable of sequestering diatomic oxygen).

Accordingly, the separation columns of the oxygen separating devices described herein can be removable from the device and replaced by another separation column. In some embodiments, each separation column can be packaged in such a way that a user of the oxygen separating device may remove a cartridge containing each separation column 10,11,12 from the oxygen separating device and insert a new, replacement cartridge once, for example, the oxygen separating device alerts them to do so or they otherwise desire to do so. Other components, including heating/cooling elements, valving, air filters, and pumps (as described below) may also be included in the cartridge that can be replaced.

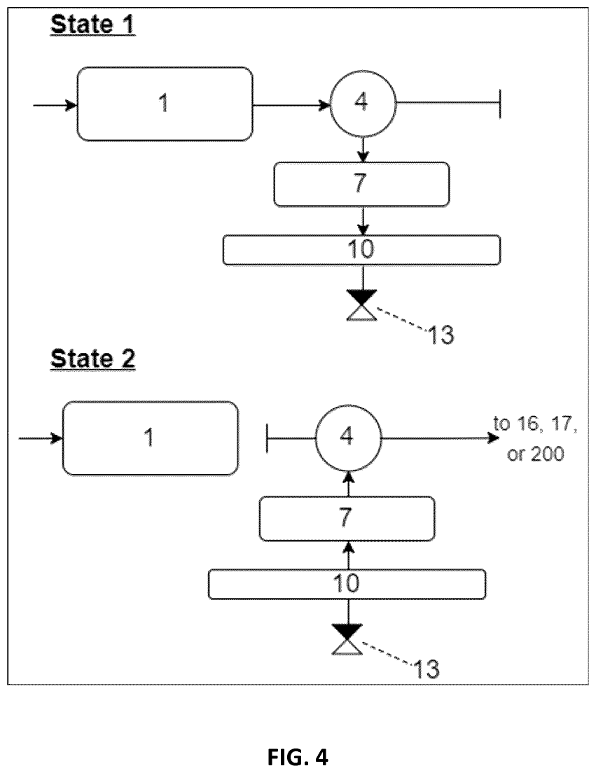

Turning now to FIG. 4, illustrated therein are two flow diagrams of a portion of the oxygen separating device 1000 of FIG. 1, each diagram depicting one of the two different configurations of the separation columns, namely when the separation columns are in the first state (e.g. state 1) and the second state (e.g. state 2). When the separation column is intended to absorb oxygen, it is said to be in the first state and the valve 4 connects the inlet pump 1 to the desiccant column 7. In this state, the oxygen from the dried air is selectively bound to the oxygen separating compound (e.g. fluomine) in the separation column 10 and all other gases from the air are vented through the one way valve 13.

When the separation column is in the second state (e.g. state 2), the valve 4 that connects the inlet pump 1 to the desiccant column 7 in the first state now connects the desiccant column 7 to the vacuum pump 16 (as described in FIG. 1). This process is reversed when the column assembly transitions from the second state back to the first state.

### Separation Column

The oxygen separating devices disclosed herein generally produce an oxygen rich (i.e. primarily oxygen) product stream through chemisorption of oxygen from a stream of air as it travels through a column packed with an oxygen separating compound (e.g. fluomine).

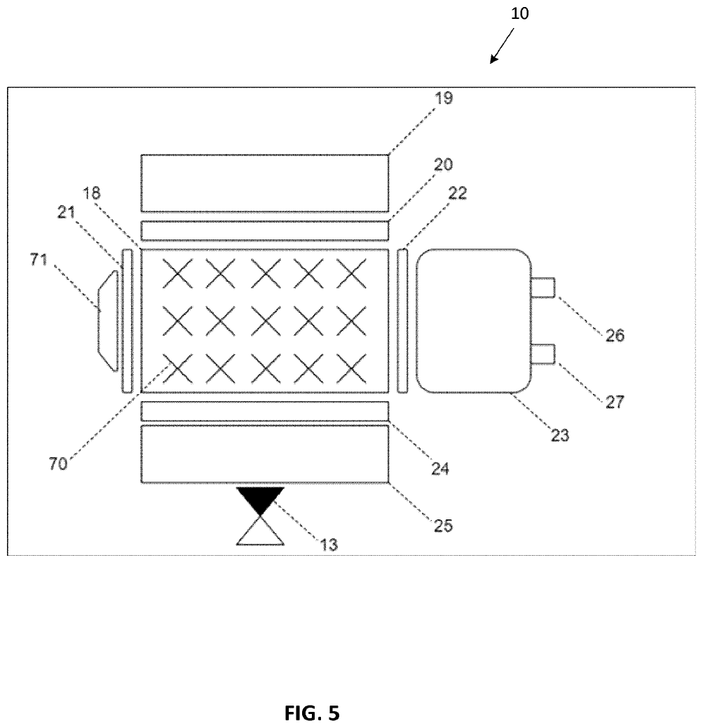

Turning now to FIG. 5, illustrated therein is one example of a separation column 10,11,12. In the embodiment of the separation column 10,11,12 shown in FIG. 5, air is introduced through an inlet manifold 19 where it expands and then is sprayed through an inlet flow divider 20. The flow divider 20 spreads the flow of air across the entire cross section of column body 18 so that all of the oxygen separating compound packed into the body 18 can absorb the oxygen in the air (it should be noted that the ambient air is approximately 21% oxygen). The oxygen separating compound stored in the column body 18 generally has a high affinity and selectivity for oxygen compared to other constituents of air (e.g. nitrogen, argon, carbon dioxide, etc.). These other gases therefore generally flow through the outlet flow divider 24, into the outlet manifold 25, and through one way valve 13.

The inlet manifold 19 and outlet manifold 25 may contain a wadding material such as but not limited to glass wool to retain any of the oxygen separating compound that passes through the inlet flow divider 20 or outlet flow divider 24. The wadding material can also be packed (e.g. as a sheet or loose material) inside the column body 18 against the innermost side of one or both of the inlet flow divider 20 or outlet flow divider 24.

Oxygen that is captured by the separation column can be released from the oxygen separating compound within the column body 18 by heating the oxygen separating compound. For instance, the oxygen separating compound may be heated by a heater 21. In some embodiments, heater 21 is a low mass heater. In other embodiments, heater 21 is capable of increasing in temperature at a rate in a range of about 1° C. per second to about 500° C. per second, or at a rate in a range of about 20° C. per second to about 300° C. per second, or at a rate in a range of about 50° C. per second to about 200° C. per second or at a rate in a range of about 100° C. per second to about 500° C. per second. For example, the heater 21 can be a thick film aluminum nitride heater from Heatron Inc. (Leavenworth, Kans.). The heater 21 may be insulated with thermal insulation 71 in order to preserve the heat energy that is produced by heater 21 as well as to direct it towards the column body 23.

Heater 21 is positioned adjacent to the body 18. In some embodiments, an electrical current is conducted through the heater 21 to heat the heater 21. Heater 21 can be positioned adjacent to body 18 such that heat generated by the heater 21 is thermally conducted to body 18 and the oxygen separating compound therein. In some embodiments, heater 21 may be configured to surround body 18. In other embodiments, heater 21 may be at least partially inserted into body 18 to transfer heat to the oxygen separating compound therein.

In some embodiments, column body 18 may distribute heat quickly and evenly to the oxygen separating compound therein via a high surface area structure 70. High surface area structure 70 extends throughout the column body 18 between an inlet and an outlet of the column body 18 such that at least a portion of the high surface area structure 70 receives heat from heater 21 (e.g. directly or indirectly). High surface area structure 70 may be partially in contact with body 18. In some embodiments, high surface area structure 70 can be made from a thermally conductive material and transfer heat received from the heater 21 to the oxygen separating compound contained therein. In some embodiments, high surface area structure 70 can include a plurality of compartments that retain the oxygen separating compound. High surface area structure 70 may transfer heat more efficiently than the oxygen separating compound itself. High surface area structure 70 increases a surface area of the oxygen separating compound exposed to heat from the heater 21 when the oxygen separating compound is packed in the compartments of the high surface area structure 70. Accordingly, high surface area structure 70 may distribute heat evenly throughout the body 18. In other embodiments, high surface area structure 70 may minimize a heat gradient across the column body 18 extending from the heater 21 when the heater 21 is positioned on one side of the column body 18 or minimize a heat gradient through the column body 18 extending from the heater 21 to an wall of the column body 18 when the heater is positioned in the column body 18. It should be noted that the heater 21 and the column body 18 may have heat sensors to measure the temperature of the heater 21 and the column body 18, respectively. Further, column body 18 may include a photosensor to indicate a colour change of the oxygen separating compound to determine a degree of oxygen loading on the oxygen separating compound.

In some embodiments, the column body 18, the high surface area structure 70 and/or the oxygen separating compound are heated by the heater 21 to a temperature in a range of about 40° C. to 120° C., or to a temperature in a range of about 60° C. to 100° C., or to a temperature in a range of about 80° C. to 90° C., to release oxygen selectively bound to the oxygen separating compound.

In some embodiments, the temperature to which the column body 18, the high surface area structure 70 and/or the oxygen separating compound can be selected based on a rate and/or an amount of oxygen to be produced by the device.

When transitioning from the second state to the first state, heat should be dissipated quickly from the column body 18 and its contents (i.e. high surface area structure 70 and the oxygen separating compound). The use of a heat pump 22 to transfer heat energy into a heat removal apparatus (e.g. cooling block 23) may facilitate this. Heat energy may then be picked up by a flowing liquid through the liquid cooling block 23 and dissipated elsewhere on the device. The liquid enters the cooling block 23 through the cooling block inlet 26 and exits the cooling block 23 through the cooling block outlet 27 after having gained thermal energy. The liquid may be but is not limited to water, ethylene glycol, diethylene glycol, propylene glycol, any mixture of these or the like.

The heat pump 22 can be operated such that it achieves peak efficiency and converts the maximum electrical power into a thermal energy gradient. For instance, this may occur depending on the current thermal gradient that exists and the amount of electrical power that is supplied to the heat pump 22. While a column is in the second state, the heat pump 22 can be operational along with the heater 21. This may increase the rate of heating of the oxygen separating compound within the column body 18 and serve to decrease the overall heating time. This may remove thermal energy from the liquid which flows through the cooling block 23.

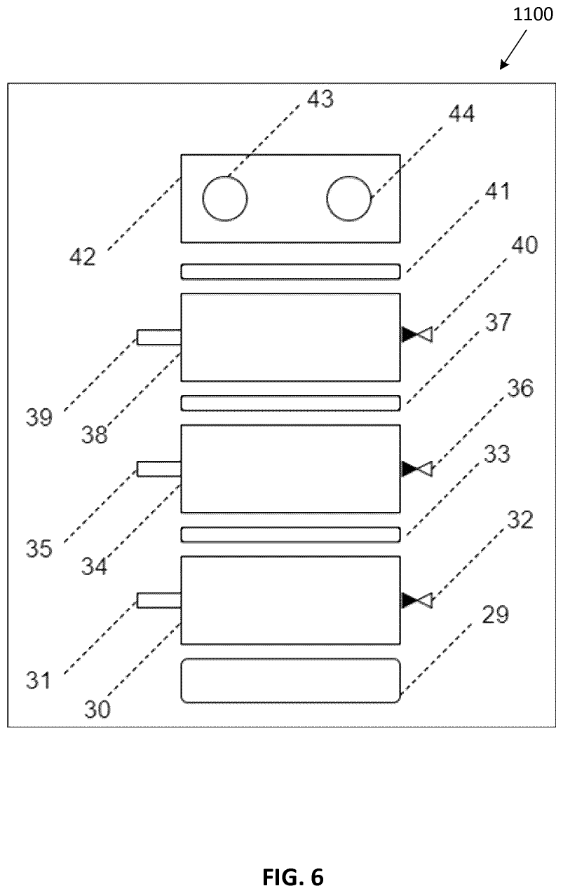

Turning now to FIG. 6, an oxygen separating device 1110 is provided, according to another embodiment. In this embodiment, a heater 29 can provide heat to a column body 30. The oxygen separating compound packed into the column body 30 can react to heating by heater 29 by releasing the oxygen it has absorbed. Heat pumps 33, 37,41 are placed between any number of column bodies 30,34,38 and used to move the heat from one column body 30,34,38 to an adjacent column body in a direction away from the heater 29. As each column body 30,34,38 is heated using the heat energy that is either transferred using the heat pumps or directly from the heater, the oxygen separating compound stored inside the column body 30 releases oxygen through each respective column inlet/outlet 31,35,39.

In some embodiments, a liquid cooling block 42 having a cooling liquid inlet 43 and cooling liquid outlet 44 is placed into contact with the final heat pump 41 in order to dissipate the heat from the system.

The oxygen separating compound within each column body 30,34,38 is able to reabsorb oxygen by passing air through the column inlet/outlet 31,35,39. The air, now stripped of oxygen, is allowed to vent through a one-way valve 32,36,40 which allows unidirectional flow out of the column bodies 30,34,38.

In this embodiment, oxygen can be continuously or semi-continuously provided as the heat energy supplied by the heater 29 travels as a pulse through each of the column bodies 30,34,38. The oxygen stored therein will be released from each column sequentially to form a nearly continuous or fully continuous stream when all of the column body inlet/outlets 31,35,39 are connected together as was shown in FIG. 5.

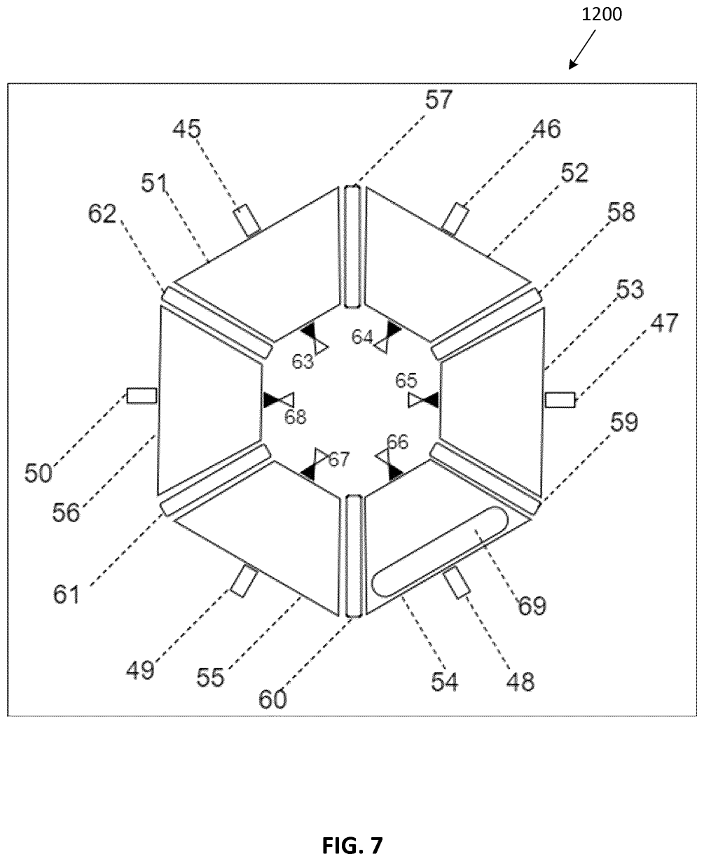

Turning now to FIG. 7, illustrated therein is an oxygen separating device 1200 according to another embodiment. In this embodiment, oxygen separating device 1200 is intended to reduce the power consumption (relative to devices 1000 and 1100) and remove the need for liquid cooling through means of the cooling block 42 that was necessary in the embodiments shown in the previous figures. In this embodiment, any number of columns can be placed together such that the first and last columns are also adjacent to each other. The column bodies 51,52,53,54,55,56 are in thermal contact with heat pumps 57,58,59,60,61,62, which are each positioned between two column bodies. The heat pumps 57,58,59,60,61,62 can, in this configuration, simultaneously heat one column while cooling another as it is on the opposite side of the heat pump 57,58,59,60,61,62.

A heater 69 may be placed into thermal contact with the first column body 54 in order to initiate the cycle and force the column body 54 into state 2. The adjacent heat pump 59 is then turned on after a short time and removes a large amount of heat from the first column body 54 which is cooled as a result. The heat is pumped into the second column body 53 which, as a result or heating, enters state 2 and releases oxygen from the oxygen separating compound stored within. It should be noted that the inclusion of the heater 69 is optional and may not be required to initiate the heating process, since any of the heat pumps 57,58,59,60,61,62 may potentially offer this utility on their own.

The airflow for this embodiment is controlled in the exact same manner as the embodiment shown in FIG. 5. Air enters each of the columns through the column inlet/outlet 45,46,47,48,49,50. Air is stripped of its oxygen and the resulting gases travel back into the surroundings once they pass through each column body 51,52,53,54,55,56 through any of the one way valves 63,64,65,66,67,68. The stored oxygen is then released from a column once it enters state 2, the oxygen then flows through the column inlet/outlet 45,46,47,48,49,50 and is pumped to the user whether it is stored in an accumulation chamber 17 or not.

The desiccation of the air is assumed to occur in this embodiment as well, this process occurs in the same manner as embodiment 1 and the desiccation chambers 7,8,9 are not shown in FIG. 7 for simplicity. It can be said that the air is dry prior to flowing into any of the column inlet/outlets 45,46,47,48,49,50.

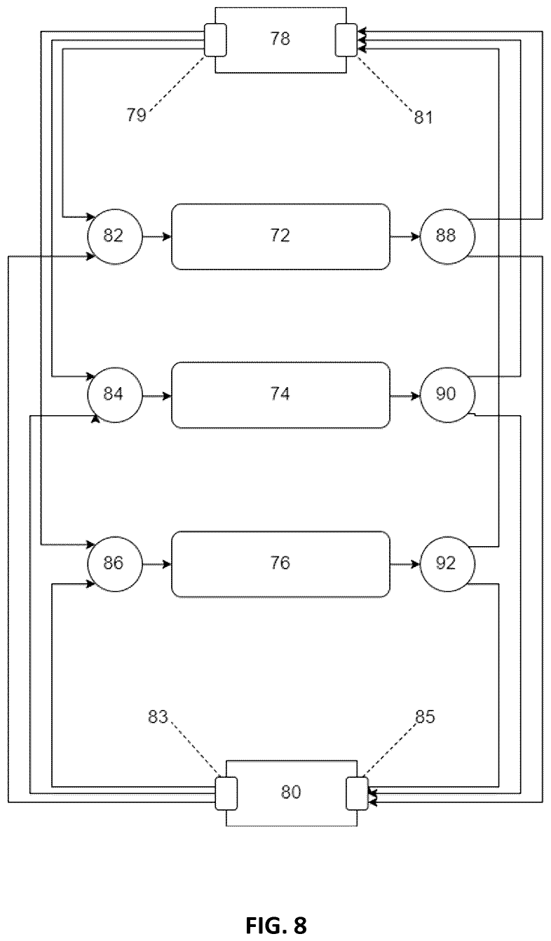

Turning now to FIG. 8, in this embodiment, any number of separation columns 72,74,76 is heated and cooled using a hot 78 and cold 80 liquid supply respectively. The hot liquid supply 78 has a means of warming a liquid such as water and pumping it through an outlet 79. The warmed liquid can travel freely to any of the column inlet three-way valves 82,84,86.

It should be noted that the high surface area structure 70 shown in the embodiment of FIG. 5 is also in this embodiment, however this structure is hollow to provide for liquid to flow through it. This structure is positioned inside of the separation columns 72,74,76 similarly to as was previously described, except now the structure may also connect to the inlet three-way valves 82,84,86 and outlet three-way valves 88,90,92 of each separation column 72,74,76.

Thus as an example, in order to transfer a separation column 72 to state 2, the hot liquid from the hot liquid supply outlet 79 may flow through the inlet three-way valve 82, traverse the separation column 72 through the hollowed high surface area structure 70 of embodiment 1, through the outlet three-way valve 88, and return to the hot liquid supply inlet 81. Similarly, in returning this separation column to state 1, the cold liquid can flow from the cold liquid outlet 83, through the inlet three-way valve 82 which has now changed configuration to connect the cold liquid supply 80 to the separation column 72, traverse the separation column 72 through the hollowed high surface area structure 70 of embodiment 1, through the outlet three-way valve 88 which has now changed configuration to connect the separation column 72 to the cold liquid supply inlet 85 and back into the cold liquid supply inlet 85. A similar mechanism of heating is possible for any number of additional separation columns 72,74,76.

Finally, it is noted that all other components dictating the flow of air and oxygen into and out of the separation column are also present in this embodiment, however they have been excluded from FIG. 8 for simplicity. This is referring to the desiccant columns 7,8,9 and valves 4,5,6 particularly. In this embodiment, air which is purged of oxygen after it has traversed a separation column 72,74,76 in state 1 must then exit the column through a one way valve 94,96,98 that returns this de-oxygenated air back into the surroundings. The collected oxygen is then harvested from each column separately as they are heated and it can then be stored in an accumulation chamber 17 or delivered directly to the user.

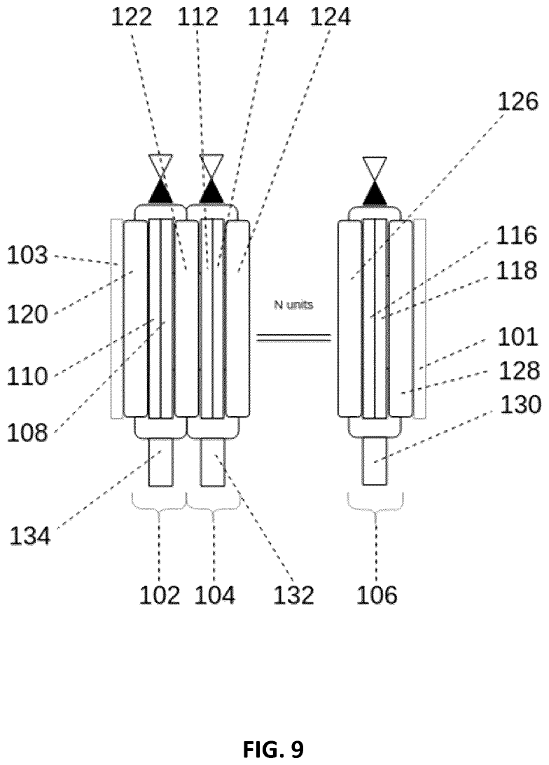

As shown in FIG. 9, in this embodiment, separation columns 102,104,106 are arranged in a stack to improve heat transfer and optimize cycle times (e.g. transitions between the first state and the second state). This design is similar to the embodiment shown in FIG. 7, in exception to the thin layers of oxygen separating compound 108,110,112,114,116,118 being in direct thermal contact to a similarly thin heat pump 120,122,124,126,128. This base column unit 102,104,106, can be stacked or used in any quantity to provide the desired oxygen flow and power requirements. The thin layers of oxygen separating compound 108,110,112,114,116,118 allow fast and direct heat transfer, crucial to optimizing cycle times and providing the most oxygen with minimal mass requirements.

The oxygen separating compound 108,110,112,114,116,118 may be in thermal contact with the heat pumps 120,122,124,126,128. The heat pumps 120,122,124,126,128 are used to heat the columns on one side and cool them on the opposite side. The hot and cold sides switch at regular intervals. Each side of the heat pump is sealed and isolated from the other side. Each column that is state-synchronized with any other column may have their respective inlet manifolds 130,132,134 connected in parallel. 101,103 represent the last layer at each end of the stack, which may be a final layer of oxygen separating compound or alternatively a heat sink depending on the size of the stack.

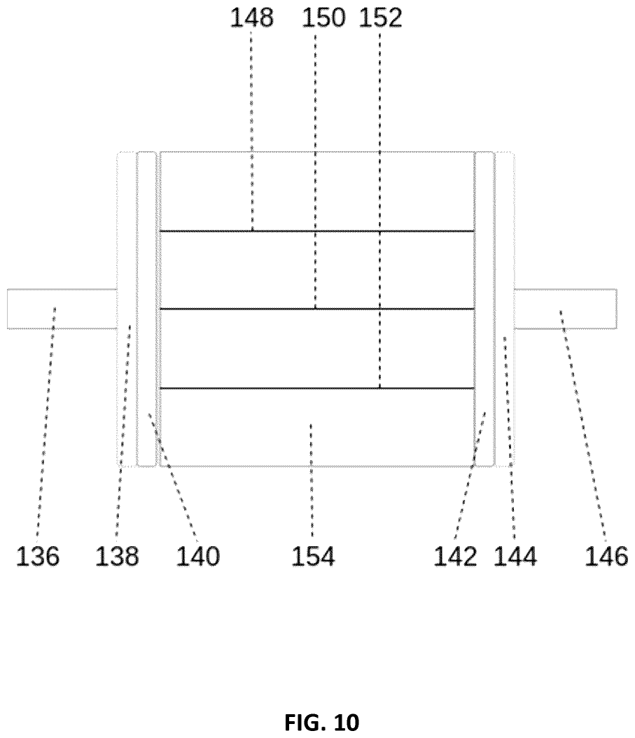

With a thin compressed layer of oxygen separating compound, air flow is restricted. FIG. 10 shows how air channels are templated into each section to allow for effective oxygen uptake during state 1 and effective oxygen release during state 2. The number of channels and each respective size is dependent on the geometry of the compressed oxygen separating compound and varies the state 1 and state 2 total cycle time. In state 1, regular air enters through the inlet manifold 136. The air then may pass through wadding material 138 and a flow divider 140. This allows air flow to pass through the air channels 148,150,152 in the oxygen separating compound. The oxygen separating compound absorbs the oxygen and the residual air flows through the wadding 142 and flow divider 144 is expelled through valve on the outlet manifold 146. In state 2, oxygen separating compound releases the oxygen which flows from the air channels 148,150,152 through the inlet air manifold 136 and through a 3-way valve which is directed to the user.

The desiccation of the air occurs in this embodiment as well. This process occurs in the same manner as embodiment 1 and the desiccation chambers are not shown in FIG. 9 for simplicity. It can be said that the air is dry prior to flowing into any of the column inlet/outlets.

### Oxygen Separating Compound Processing

In some embodiments, the oxygen separating compound (e.g. fluomine) that is packed into the separation columns 10,11,12 within the column body 18 can be processed such that it releases oxygen at a lower temperature. For instance, decreasing the individual particle size of the oxygen separating compound crystals may result in the oxygen separating compound releasing oxygen at a lower temperature. Some examples of processes that can be employed to generate oxygen separating compound with reduced particle size include but are not limited to: precipitation from compressed antisolvent, cryogenic grinding, any other rapid expansion spraying technique, sol gel synthesis methods, or others. These processes generally occur after the initial synthesis of the compound which is conducted.

Once the oxygen separating compound is processed such that it releases oxygen at a lower temperature, the temperature difference between the first state and the second state may also be reduced. This may lead to increased power savings and longer battery lifetime for the device as a portable oxygen generating unit. For instance, the second state can be achieved once the temperature of the oxygen separating compound dispersed within the high surface area structure 70 reaches a temperature in a range of about 40° C. to about 80° C. The first state is achieved when the oxygen separating compound cools to a temperature in a range of about 10° C. to about 60° C.

Because the temperature used to release oxygen during the second state is reduced, this leads to a slower rate of irreversible oxidation of the oxygen separating compound. Less oxidation of the compound means that the useful lifetime of the compound can be extended, and oxygen separating compound can undergo increased number of state cycles before needing to be replaced.

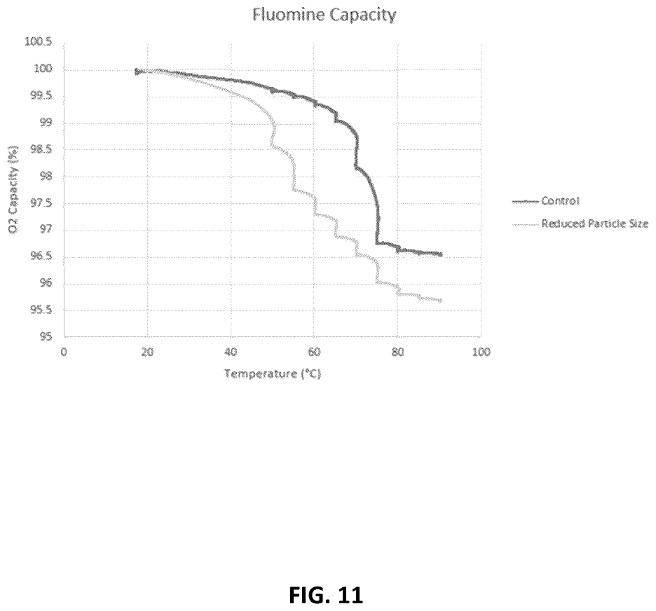

In addition to the increased lifetime of the compound, decreasing the particle size of the oxygen separating compound also results in an increased capacity of the oxygen separating compound to selectively bind oxygen from the air. FIG. 11 shows that as the fluomine particle size is reduced, there is a marked increase in the total amount of oxygen that can be absorbed by the oxygen separating compound.

The oxygen separating compound will be washed in water, water containing mother liquor, water containing piperidine, ethanol, isopropyl alcohol or any other short chained alcoholic molecule in order to extract water and/or piperidine molecules from the crystal and activate it. Other molecules may also be extracted from the compound in order to activate the material for accepting oxygen.

### Software Controls

The basic logical operation of the device is a simple state machine, which mirrors the states of the absorbent; absorption and desorption. Although absorption and desorption are the active material states, intermediate states are present in order to transition between the two states. The states are triggered by a combination of pressure, temperature, colour and oxygen concentration. An example of the states and notable actions taken are listed:

| State | Action | Trigger for next state |
|---|---|---|
| Absorption | column cools to the desired | Requires the temperature to be |
| (state 1) | temperature and absorbs | below or equal to the absorption |
| | oxygen | temperature |
| | | Requires sufficient air volume to |
| | | saturate (fluomine) with oxygen |
| Intermediate A | air is removed from the column | Requires the pressure within the |
| | body through reduced pressure | column to be below the specified |
| | and heating begins | desorption pressure |
| Intermediate B | oxygen bound to the | Requires that the setpoint |
| | (fluomine) begins to be released | temperature for desorption has |
| | to the user or delivered to the | been reached |
| | accumulator | |
| | transient heating process | |
| | continues | |
| Desorption | oxygen is released from the | the temperature is greater than |
| (state 2) | (fluomine) | or equal to the desorption |
| | oxygen bound to the | temperature |
| | (fluomine) is released to the | (fluomine) is emptied of oxygen |
| | user or delivered to the | |
| | accumulator | |
| | temperature is maintained, but | |
| | no further heating | |

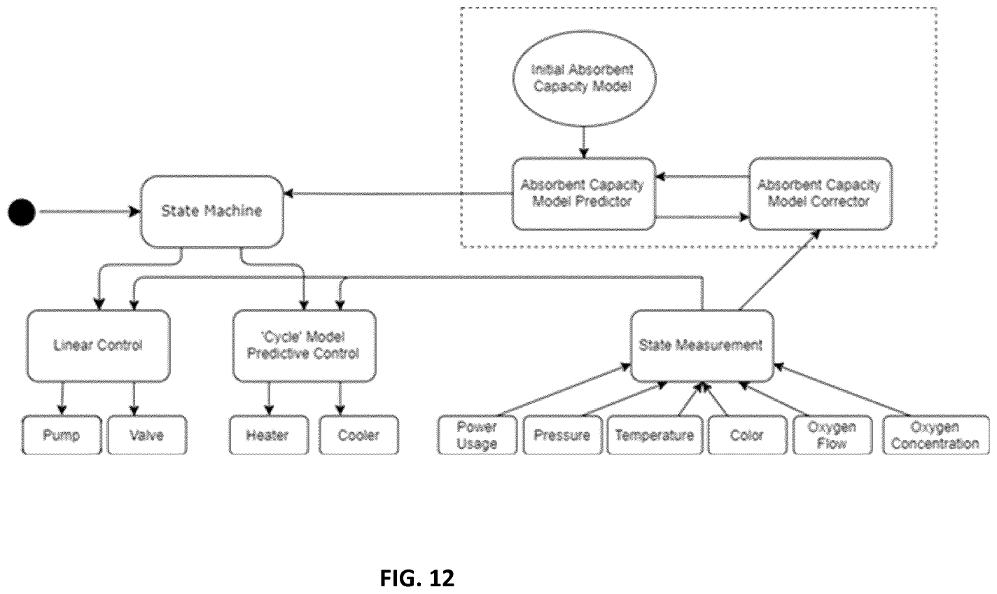

As shown in FIG. 12, the state machine controls the states of each column and manages the controllers to cycle the oxygen system appropriately, as described below.

A combination of controllers (Lead Lag, PID, bang bang, etc.) are used to control heat and air flow. The release of oxygen is non-linear with respect to the energy input. Constraints on cycle time and flow rate require Model Predictive Control (MPC) to be used to optimize operation.

Over time, the capacity of the absorbent oxygen separating compound is reduced. A time-variant MPC is used to take into account this degradation and ensure that oxygen production can be marginally maintained over a pre desired time frame. This is controlled through two methods. Firstly, the cycle time is decreased, producing more oxygen per second. Secondly, the temperature swing is increased in order to use a larger fraction of the total oxygen capacity. In both cases, the oxygen flow rate is kept consistent despite the decreasing capacity of the material. Finally, the controller minimizes capacity degradation rate of the oxygen separating compound by reducing the amount of oxygen while the column transitions from desorption state (state 2) to absorption state (state 1). The time spent at elevated temperatures is also minimized.

Oxygen capacity and degradation rate of the absorbent material cannot be directly measured while using the device, but can be estimated from flow, oxygen purity and pressure sensors. Kalman filtering of these parameters while cycling the absorbent material provides an accurate estimate for the total capacity and degradation rate of the absorbent at any point in time. The dotted area in FIG. 12 demonstrates how this feature is incorporated into nominal software flow.

Atypical operation of the device is progressively tracked by the software. Significant variance from model parameters sounds an alarm indicating a requirement for maintenance. For example, if the degradation rate of the absorbent exceeds the expected amount, an updated maintenance status will be displayed for the user. If at any point, one individual column fails, the remaining operational elements of the device can compensate for the reduced performance of that faulty component. Additional safety features may include alarms for low oxygen concentrations, low flow rates, abnormal mechanical vibrations, low battery voltage/current, filter status.

While the above description provides examples of one or more apparatus, methods, or systems, it will be appreciated that other apparatus, methods, or systems may be within the scope of the claims as interpreted by one of skill in the art.

1. A system for separating oxygen from air, the system comprising:
a separating column comprising:
an inlet;
an outlet downstream from the inlet;
a body connected to the inlet and the outlet; and
an oxygen separating compound packed inside the body, the oxygen separating compound configured to selectively and reversibly bind oxygen from air received through the inlet upon contact with the air and to release the selectively bound oxygen upon being heated;
a heater thermally coupled to the separating column to provide the heat to the separating column for releasing the selectively bound oxygen from the oxygen separating compound;
a heat removal apparatus to remove heat from the oxygen separating compound; and
an air flow controller for controlling entry of the air into the separating column and release of the bound oxygen from the separating column.

2. The system of claim 1, wherein the oxygen separating compound is a chelating compound.

3. The system of claim 1, wherein the oxygen separating compound is fluomine or a derivative of fluomine.

4. The system of claim 1, wherein the system has a first state where oxygen is being selectively bound to the oxygen separating compound and a second state where the selectively bound oxygen is released from the oxygen separating compound.

5. The system of claim 4, wherein the temperature of the oxygen separating compound when the system is in the second state is in a range of from about 40° C. to 120° C.

6. (canceled)

7. The system of claim 4, wherein the temperature of the oxygen separating compound when the system is in the second state is in a range of from about 80° C. to 90° C.

8. The system of claim 1, wherein the heat removal apparatus is a cooling block positioned adjacent to the separating column to remove heat from the separating column.

9. The system of claim 8, wherein the cooling block comprises a liquid for removing heat from the oxygen separating compound.

10. The system of claim 9, wherein the liquid is water, ethylene glycol, diethylene glycol, propylene glycol or a mixture thereof.

11. The system of claim 1, wherein the separating column further comprises a high surface area structure disposed in the body to transfer heat from the heater to the oxygen separating compound.

12. The system of claim 11, wherein the high surface area structure comprises compartments for retaining the oxygen generating compound.

13. The system of claim 1 further comprising a vacuum pump for removing the selectively bound oxygen from the separation column once the selectively bound oxygen has been released from the oxygen separating compound.

14. The system of claim 1, wherein the inlet of the separation column is an outlet for the selectively bound oxygen.

15. (canceled)

16. (canceled)

17. The system of claim 1, wherein the oxygen separating compound has a particle size in a range of about 50 μm to 50 nm.

18. (canceled)

19. The system of claim 1 further comprising at least one sensor for monitoring system conditions, the at least one sensor being one of: a heat sensor, a color sensor, an energy sensor, a pressure sensor, an oxygen flow rate sensor and an oxygen concentration sensor.

20. (canceled)

21. (canceled)

22. The system of claim 19 further comprising a controller configured to receive information from the one or more sensors and, in response to receiving the information, control system parameters to minimize oxygen degradation over time.

23. The system of claim 19 further comprising a controller configured to receive information from the one or more sensors and, in response to receiving the information, control a cycle time of the system to produce more oxygen per second.

24. The system of claim 19 further comprising a controller configured to receive information from the one or more sensors and, in response to receiving the information, control a degradation of the oxygen separating compound by minimizing a time that the system spends operating in the second state.

25. A device for separating oxygen from air, the device comprising
an inlet;
an outlet downstream from the inlet;
a body connected to the inlet and the outlet, the body configured to house an oxygen separating compound inside the body, the oxygen separating compound configured to selectively and reversibly bind oxygen from air received through the inlet upon contact with the air and to release the selectively bound oxygen upon being heated, the body configured to receive heat from a heater to release the selectively bound oxygen from the oxygen separating compound; the body configured to provide heat to a heat removal apparatus to remove heat from the oxygen separating compound; the body coupled to an air flow controller for controlling entry of the air into the body and release of the bound oxygen from the body.

26.-42. (canceled)

43. A method for separating oxygen from air, the method comprising;
receiving the air at a device for separating oxygen from the air, the device having a body configured to house an oxygen separating compound, the oxygen separating compound configured to selectively and reversibly bind oxygen from the air and to release the selectively bound oxygen upon being heated;
applying heat to the oxygen separating compound to release the selectively bound oxygen; and
extracting the selectively bound oxygen from the device.
